(19) United States
(12) Patent Application Publication
(10) Pub. No.: US 2011/0219703 A1
(43) Pub. Date: Sep. 15, 2011

(54) COATED SOLID PARTICLES

(76) Inventor: Thomas Fuchs, Murg (DE)

(21) Appl. No.: 13/060,818

(22) PCT Filed: Aug. 25, 2009
(86) PCT No.: PCT/EP09/06142

§ 371 Date: May 24, 2011

(30) Foreign Application Priority Data
Aug. 25, 2008 (DE) 10 2008 039 459.9

(51) Int. Cl. C09K 3/14; C09C 1/68

(52) U.S. Cl. 51/308; 51/309; 51/307

(57) ABSTRACT

The invention relates to a method for treating the surfaces of solid particles to improve the processability of the solid particles in the electrostatic field and to reduce the dust formation which occurs during the processing of the solid particles.

The present invention relates to coated solid particles from the group corundum, melted corundum, sintered corundum, zirconium corundum, silicon carbide, boron carbide, cubic boron nitride, diamond and/or mixtures thereof that have a surface treatment in the form of a physically applied coating.

Such solid particles are used for example as abrasive grains in a great variety of grain sizes in bound and loose form for grinding processes, with which all of the known materials can be processed. In general, in the use of abrasive grains a distinction is made between the so-called bound grinding materials, which are understood to include grinding disks, grinding stones or grinding rods, in which the abrasive grains are molded with a ceramic mass or an artificial resin to produce the corresponding abrasive bodies and are then bonded by means of a heat treatment, as well as to produce the grinding materials on a support or the flexible grinding materials in which the abrasive grains are fixed on a support (paper or linen) with the aid of a binder (usually artificial resin), in order in this manner to obtain abrasive-coated paper or grinding belts.

In the production of grinding materials on a support, the application of the abrasive grains onto the support, such as e.g. paper or belts, is usually carried out these days in so-called dispersion units, wherein the abrasive grains are deposited dispersed as homogeneously as possible on a conveyor belt that transports the abrasive grains into an electrostatic field, which is embodied in that a direct voltage is applied between two electrodes that are arranged at a particular distance from one another. At the same time a glued support runs over rollers in the electrostatic field above the transport belt with the abrasive grains in the opposite direction, at a particular distance and parallel to the transport belt, so that the coated side shows in the direction of the transport belt. In the electrostatic field the abrasive grains, which lie loose on the transport belt, are now excited and are accelerated in the direction of the counter electrode, so that they leap against the glued support that is arranged in front of the counter electrode and adhere firmly there. The goal thereby is to obtain a grinding belt or abrasive-coated paper that is covered as densely and uniformly as possible.

Frequently in these production processes the problem occurs that the abrasive grains are then distributed unevenly on the support, or that the dispersion density is too low. These problems can partially be solved by increasing the voltage or else by changing the distance between the transport belt and the glued support or the distance between the electrodes. However, this is always only a temporary solution, since the external conditions, such as e.g. atmospheric humidity, have a great influence on the dispersion behavior of the abrasive grains. It is true that it is possible to establish a constant climate in a dispersion unit to a certain extent, but for reasons of production engineering, it is usually not possible also to adapt the abrasive grains, which as a rule are transported and stored in paper bags for quite a long period of time under climatic conditions that are completely different, to the climate completely in a reasonable length of time.

In this connection it has also been established that in particular the surface conductivity of the abrasive grain has an influence on the processibility of the abrasive grain in the electrostatic field and that it is advantageous if water is attached on the surface of the abrasive grain, as a result of which the surface conductivity is improved. Thus in EP 0 304 616 B1, a surface-treated abrasive grain based on aluminum oxide is described that is coated with a hygroscopic and/or hydrophilic substance, as a result of which a permanent film of moisture is to be embodied on the surface of the abrasive grain, which film ensures an adequate surface conductivity and allows a homogeneous processing in the electrostatic field.

In EP 0 856 037 B1, abrasive grains are described that are based on aluminum oxide, which have a coating on their surface that is composed essentially of an aluminum (tri)hydroxide and a sodium silicate. In this case too, an abrasive grain is obtained whose processability in the electrostatic field is largely independent of the respective time- and place-associated climatic conditions (atmospheric humidity).

However, the surface treatment of abrasive grains for improving the dispersibility holds the danger that too much moisture attaches on the surface of the abrasive grain and for example the flowability of the abrasive grains deteriorates, as a result of which an ideally homogeneous distribution of the abrasive grains on the transport belt is prevented. However, a non-uniform distribution on the transport belt automatically leads to a nonuniform distribution on the grinding belt and thus to a worsening of the product. Also, too high a moisture content can have a negative effect on the binding of the abrasive grain in the artificial resin matrix.

In the past, attempts have therefore been made to minimize the surface treatment of abrasive grains for improving the dispersibility to such an extent that the flowability of the abrasive grains or their binding in the artificial resin matrix does not suffer under too severe a treatment. Of necessity, problems with the excitability of the abrasive grain in the electrostatic field have been eliminated by changing the field conditions (distance, voltage).

A further problem with the electrostatic dispersion of abrasive grains, in particular in the production of grinding belts, is the development of dust as the abrasive grains are fed into the dispersion unit. The abrasive grains are usually shaken hereby from 25 kg sacks into an open hopper, wherein the dust adhering to the abrasive grains rises above the hopper as a dust cloud, which is associated with an enormous health hazard to employees working in the unit. Attempts to solve this problem by installing suction units in the area of the hopper opening were not particularly successful, since for an efficient dust suction, the suction unit must be positioned relatively close to the hopper opening, which then leads to hindrances in filling the hopper.

Equipping the personnel with appropriate safety devices, such as e.g. mouth protection, dust mask, etc., is also only partially successful, since the amounts of dust adhering to the abrasive grain are relatively large as a rule, so that a complete protection is difficult. In addition, such protective measures involve an additional difficulty with the activity and are thus undesirable.

The dust adhering to the abrasive grain originates from the reduction of the abrasive grain during its production. Large amounts of extremely fine dust are formed thereby, which can be suctioned off for the most part, but wherein still relatively large amounts of abrasive grain remain adhered and then later are released for example when the abrasive grain sacks are emptied.

Thus it continues to be a problem to obtain abrasive grains that on the one hand exhibit an ideal dispersion behavior in the electrostatic field and an optimal binding in an artificial resin matrix, and on the other hand do not cause any hazard to the personnel in the dispersion unit due to dust.

Moreover it is required that a necessary additional treatment not be too expensive in order to achieve this goal, since abrasive grains are mass products that must be produced as cost-effectively as possible. Thus for example even a simple additional washing of the abrasive grains to eliminate dust and a subsequent drying are excluded as the means of choice, since these manipulations are associated with relatively high expenditures of time and personnel, as a result of which the manufacturing costs for the abrasive grains are noticeably burdened.

The object is achieved by solid particles from the group corundum, melted corundum, sintered corundum, zirconium corundum, silicon carbide, boron carbide, cubic boron nitride, diamond and/or mixtures thereof with the features of claim 1. Advantageous embodiments of the present invention are subject matter of the subordinate claims.

A subject matter of the present invention is also a method for the production of surface-treated solid particles as well as their use for the production of grinding materials on a support as well as their use in wear-resistant surface coatings.

In the search for the solution to the above-described problem it was found that outstandingly suitable solid particles for processing in the electrostatic field can be obtained in that they undergo a surface treatment in the form of a physically applied coating with an aqueous solution of a polyol. Thereby even small amounts of polyol and treatments with 0.001 to maximum 5% by weight polyol, relative to the untreated solid particles, are sufficient to obtain an optimum effect. With preferred embodiments of the present invention, approx. 0.01 to approx. 1.0% by weight polyol, relative to the untreated solid particles, are used.

Suitable polyols are linear or branched polyols with 2 to maximum 6 carbon atoms. Particularly preferred polyols in the sense of the present invention are short-chain polyols such as e.g. glycol, propane diol, butane diol, and glycerol.

The surface treatment is extremely simple, wherein the solid particles are first placed in a mixer and then during the mixing are sprayed with an aqueous solution of at least one polyol. Thereby even small percentages of polyol in the aqueous solution are sufficient to achieve an effect, so that the preferred ratio of polyol to water is preferably between 2:1 and approx. 1:40. At this point it should be mentioned that tests with undiluted glycol have shown that even pure polyols can be used to improve the dispersibility, whereby, however, it is then frequently a problem to achieve an ideally homogeneous mixing with the solid particles.

In an advantageous embodiment of the present invention, the aqueous coating solution additionally contains a waterglass diluted with water, wherein the amount of waterglass is advantageously 0.001 to 2.0% by weight, relative to the untreated abrasive grain.

A further advantageous embodiment provides that the solid particles are previously treated with an organosilane as adhesive. The treatment with organosilanes improves the strength of the binding of the solid particles in the artificial resin matrix, but at the same time this treatment worsens the dispersion behavior of the solid particles. This worsening can again be eliminated with an additional treatment with the usual hydrophilic or hygroscopic substances for improving the dispersibility, wherein however the strength of the binding, in particular the wet strength, then suffers again. Surprisingly, it has now been found that the dispersion behavior of solid particles that are treated with an organosilane to improve the binding, can be improved with a lasting effect by a subsequent treatment with an aqueous polyol solution, without the binding suffering later thereby. Apparently the polyol harmonizes with the artificial resin binding in the final cross-linking by polycondensation.

Suitable silanes for improving the binding are organosilanes with the general empirical formula (RO)₃—Si—(CH₂)ₙ—X, where R is an organic radical selected from the group methyl, ethyl, i-propyl and methoxymethyl, n is an integer between 0 and 12 and X is a functional group selected from the group vinyl, acryl, methacryl and/or amine.

Preferred silanes for the above-described use are those selected from the group 3-aminopropyltriethoxysilane, vinyl triethoxysilane, 3-methacryloxypropyltrimethoxysilane, wherein the amount of organosilane relative to the untreated solid particles, is preferably 0.01 to 2.0% by weight and the adhesives are likewise preferably used as a diluted aqueous solution.

Through the surface treatment with a polyol-containing aqueous solution, it is possible to obtain solid particles that can be processed outstandingly well in the usual dispersion units for the production of grinding agents on a support. Since the treated abrasive grains have an outstanding dispersion behavior, the treatment amounts can be kept low, no that problems with the flowability can be avoided and a homogeneous distribution of the abrasive grains on the transport belt into the dispersion unit is ensured. At the same time due to the surface treatment the extremely fine dust is bound on the surface with a lasting effect, so that a processing in the usual dispersion units without health hazards is ensured. In this way the dust concentration can be reduced by at least 80% compared to the untreated abrasive grains.

However, the use of the solid particles treated according to the invention is not limited to grinding materials; tests with micrograins with an average grain diameter of between approx. 3 μm and approx. 60 μm, which are used in wear-resistant surfaces, have shown that such grains can likewise be processed electrostatically outstandingly well if they have previously undergone a treatment according to the invention. Although the electrostatic coating of papers or films with wear-resistant particles has not yet become generally accepted, it can be expected that the method will find ever wider applications.

The present invention is explained in detail below on the basis of examples, wherein for reasons of availability of corresponding measurement results, only the use in grinding materials described, wherein however no limitation is to be seen. Thus for example the results with the ZWSK 180 fine grains (average grain diameter 70 μm) and ZWSK 220 (average grain diameter approx. 60 μm) (see Examples 1 through 5, comparison Examples 1 through 4) can be transferred without difficulty to the micrograins mentioned above that are used for wear-resistant layers.

### EXAMPLE 1

### Noble Corundum White, ZWSK 180

1 metric ton of melted corundum (Noble Corundum White, ZWSK 180, Treibacher Schleifmittel AG) was placed in a compulsory mixer and there sprayed with 2 L of a 20% solution of aminopropyltriethoxysilane in distilled water under constant mixing. After the addition of the solution was complete, the mixing procedure was continued for about 30 min. Then the abrasive grains coated in this manner were sprayed with a solution of 500 mL glycerol in 1.5 L water under further mixing. Also in this case the mixing process was continued for about 30 min. after the addition of the solution, on that a total mixing procedure of approx. 1.5 hours resulted. The abrasive grain mixture obtained in this manner was then dried with the aid of a belt dryer at 80° C.

### COMPARATIVE EXAMPLE 1

### Noble Corundum White, ZWSK 180

metric ton of melted corundum (Noble Corundum White, ZWSK 180, Treibacher Schleifmittel AG) was again used. In this case, however, only a treatment with 2 L of a 20% solution of 3-aminopropyltriethoxysilane was carried out. Then the abrasive grain mixture obtained in this manner was again dried with the aid of a belt dryer at 80° C.

### EXAMPLE 2

### Noble Corundum White, ZWSK 180

The test was carried out as in Example 1. However, 3-methacryloxypropyltrimethoxysilane was used as organosilane and glycol as polyol.

### EXAMPLE 3

### Noble Corundum White, ZWSK 220

The test was carried out as in Example 1, wherein ZWSK 180 was replaced by the finer grain ZWSK 220.

### COMPARATIVE EXAMPLE 2

### Noble Corundum White, ZWSK 220

Comparative Example 2 was carried out as in Comparative Example 1, wherein in place of ZWSK 180 the finer grain ZWSK 220 was used.

### EXAMPLE 4

### Noble Corundum White, ZWSK 220

Example 4 was carried out as in Example 2; here too, however, the finer grain ZWSK 220 was used.

### COMPARATIVE EXAMPLE 3

1 metric ton of ZWSK 180 was treated as in Example 1, but in the second coating step, instead of the polyol treatment a standard treatment with 2 L of a 20% waterglass solution was carried out.

### COMPARATIVE EXAMPLE 4

As in Comparative Example 3, but 1 metric ton of ZWSK 220 was used.

### EXAMPLE 5

As in Example 3, 1 metric ton of Noble Corundum White (Alodur ZWSK 220, Treibacher Schleifmittel) underwent a silane treatment and was then mixed with 4 kg of pure glycol.

### EXAMPLE 6

### Dispersion Tests

The measurement of the dispersibility in the electrostatic field was carried out with the aid of a simple measuring instrument that is composed of a metallic base plate, the so-called support plate, and a metallic cover plate arranged above it in parallel. Onto the metallic base plate, which has a diameter of 5 cm, 5 g of the abrasive grain to be measured is distributed as homogeneously as possible. An electrostatic field with a strength of 4.2 kV/cm² is then produced between the metallic base plate and the cover plate, which has five times the diameter of the base plate, by applying a direct voltage. The abrasive grain lying on the support plate is thereby excited and leaps against the cover plate, from which it bounces back, wherein a majority of the abrasive grains no longer fall back onto the support plate due to the different size ratio of the two metal plates and the different impact angle of the individual grains. The excitement duration is 5 seconds and the residue remaining on the support plate is measured. The lower the percentage of the residue, the better the dispersion behavior of the abrasive grain. The results of the dispersion tests of Examples 1 through 5 and of the Comparative Examples 1 through 4 are summarized in table 1 below.

TABLE 1

| Abrasive | | Dispersibility = | |
|---|---|---|---|
| grain | Treatment | residue (g) | Grain breakout (%) |
| Alodur | Untreated | 1.0 | Approx. 40 |
| ZWSK 180 | Comparative | 5.0 | Approx. 10 |
| | Example 1 | | |
| | Comparative | 1.1 | Approx. 60 |
| | Example 3 | | |
| | Example 1 | 1.2 | Approx. 15 |
| | Example 2 | 0.9 | Approx. 10 |
| Alodur | Untreated | 1.7 | Approx. 50 |
| ZWSK 220 | Comparative | 4.9 | Approx. 10 |
| | Example 2 | | |
| | Comparative | 1.6 | Approx. 65 |
| | Example 4 | | |
| | Example 3 | 1.4 | Approx. 20 |
| | Example 4 | 1.1 | Approx. 15 |
| | Example 5 | 1.2 | Approx. 20 |

The discussion results listed in the above table show that a treatment to improve the dispersibility with fine grains such as e.g. grain 184 or 220 is per se not required, since the grains can be processed in the electrostatic field outstandingly well even without treatment, due to the low weight of the individual grains. In order to demonstrate this, Alodur ZWSK 180 untreated and Alodur ZWSK 220 untreated were measured for comparison, wherein it can be seen that at least approx. 70 to approx. 80% of the individual grains were excited. Through the treatment with silane to improve the binding in the artificial resin matrix, the dispersibility is lowered to almost zero, as can be seen in Comparative Examples 1 and 2. The worsening of the dispersibility can be compensated for again through a subsequent treatment with a polyol-containing aqueous solution. Comparative Examples 3 and 4 show that even with a standard treatment with waterglass, even though the dispersibility is restored, it is evident in comparative grinding tests that the binding in the artificial resin matrix is no longer ensured.

For this purpose grinding belts were produced with the abrasive grains listed in table 1, which belts were aged in an aqueous sodium hydroxide solution and then dried. Then grinding operations were carried out with the belts pretreated in this manner to test the binding, wherein a stainless steel solid material was worked on at medium pressures. After the grinding operation the corresponding grinding belts were subjected to a microscopic evaluation and the percentage of the surface of the area of the grinding belt used in the grinding without grain breakout was determined. The above-described drastic conditions of the aging in sodium hydroxide solution was selected in order to work out more clearly the differences in the strength of the binding and above all in the wet strength.

Although Comparative Examples 1 and 2 showed good binding, the silanized abrasive grain could only be processed electrostatically with great difficulty, with the result that the corresponding grinding belts were structured extremely inhomogeneously and would have been evaluated as waste under practical conditions.

Example 5 shows good dispersibility and good binding, but in this case a relatively large amount of polyol must be used to obtain an acceptable thorough mixing.

### EXAMPLE 7

### Zirconium Corundum Test Series

1 metric ton of zirconium corundum (Alodur ZK40, Treibacher Schleifmittel AG) in various grain sizes (P24 and P40) was respectively treated with various solutions in an intensive mixer under constant mixing. The standard treatment for improving the dispersibility with a pure waterglass solution (1.5 L water+500 mL 40% waterglass), a mixture according to the invention with waterglass and glycerol (1.5 L water+250 mL 40% waterglass+250 mL glycerol), a mixture according to the invention with waterglass and glycol (1.5 L water+250 mL 40% waterglass+250 mL glycol) as well as an aqueous glycol solution (1.5 L water+500 mL glycol) were used thereby as treatment solutions.

With respect to these tests it should be noted that the strength of the binding of the coarse grains having a fissured surface is not the primary problem, but rather the problems of the dispersibility itself and the dust development occurring thereby.

The treated abrasive grains were therefore tested with respect to the dust index, as well as the dispersibility.

### Measurement of the Dispersibility

The measurement of the dispersibility for the coarser grains in the electrostatic field was carried out with the aid of a measuring instrument that was composed of a metallic base plate as anode and a height-adjustable metal plate arranged parallel to it as cathode. The cathode is equipped with a suction device for fixing at the back of a glued support with a defined base area. When a direct voltage is switched on, the amount of the abrasive grains adhering firmly to the glued support in a time unit is determined by weighing the support and the dispersibility is then expressed as dispersion density (g/m²).

### Determination of the Dust Index

The measuring method for determining the dust content of powders or granular materials is based on the principle of light reduction. The sample is thereby introduced into the measuring system via a vertical pipe and the dust cloud developing thereby between the light source (laser) and detector is measured by the light reduction, which is in a direct ratio to the dust concentration and is calculated as dust index. For the dust measurement, a measuring instrument of the Anatec Deutschland GmbH company with the designation DustMon L was used. The measuring duration was 30 seconds, wherein respectively 100 g samples were measured. The dust index given by the sum of the maximum value at the beginning of the measurement and the final measurement before the conclusion of the measurement was determined.

TABLE 2

| | | | Dispersion | Dust |
|---|---|---|---|---|
| Abrasive grain | No. | Treatment | density(g/m²) | index |
| Alodur ZK40 | 7.1 | Untreated | 117 | 12.43 |
| P24 | 7.2 | Standard | 304 | 4.98 |
| | 7.3 | Glycerol/waterglass | 617 | 0.32 |
| | 7.4 | Glycol/waterglass | 598 | 0.52 |
| | 7.5 | Glycol | 458 | 0.28 |
| Alodur ZK40 | 7.6 | Untreated | 64 | 22.94 |
| P40 | 7.7 | Standard | 228 | 5.43 |
| | 7.8 | Glycerol/waterglass | 445 | 0.35 |
| | 7.9 | Glycol/waterglass | 414 | 0.43 |
| | 7.10 | Glycol | 322 | 0.29 |

All current grain sizes for zirconium corundum from P24 to P120 were tested, wherein it was found that all the grain sizes behave in the same manner in principle, so that the grain sizes P24 and P40 could be selected as representative as examples. In the measurements, the same dispersion conditions (voltage, distance, excitation time) were kept respectively for the same grain sizes.

The results listed in Table 2 show that untreated zirconium corundum abrasive grains (No. 7.1 and 7.6) have a weak dispersion behavior together with a high dust development. With a standard treatment using a waterglass solution (No. 7.2 and 7.7), the dispersion density can be more than doubled and also the dust development is already distinctly reduced. However, a dust index of approx. 5 in practice still means a severe hazard for the contact personnel. However, the further doubling of the dispersion density with the polyol- and waterglass-containing treatment (Nos. 7.3, 7.4, 7.8, and 7.9) is completely surprising. In all cases of the treatment according to the invention, the dust development is suppressed to a dust index below 1, which in practice means that it is possible to work almost dust-free. It is interesting that the treatment with a polyol (glycol) without additional waterglass (No. 7.5 and 7.10) does somewhat more poorly in relation to the dispersion behavior. Possibly in this case, however, the binding in the matrix is better, which however was not tested within the scope of the tests.

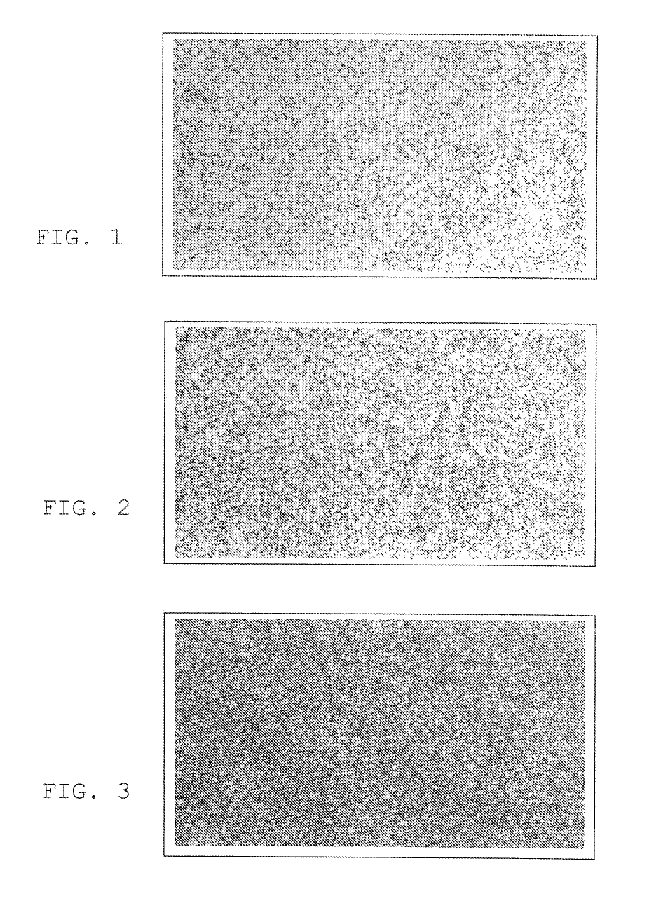

Based on FIGS. 1 through 3, the effect of the treatment according to the invention on the dispersion behavior is shown optically.

Thereby they show

FIG. 1 optical (photographic) evaluation of a dispersion test with an untreated abrasive grain,

FIG. 2 optical (photographic) evaluation of a dispersion test with an abrasive grain given a standard treatment, and

FIG. 3 optical (photographic) evaluation of a dispersion test with an abrasive grain treated according to the invention.

FIG. 1 is a photographic image of a glued support used in a dispersion test with untreated zirconium corundum abrasive grains (Alodur ZK 40 P24) after the dispersion test in the electrostatic field and thus corresponds to test No. 7.1. The dispersion image is very open and does not meet the usual production requirements for such grinding belts.

FIG. 2 shows the dispersion image of zirconium corundum abrasive grains with a standard treatment and thus corresponds to test No. 7.2. The higher dispersion density compared to the untreated abrasive grain can clearly be recognized optically.

In FIG. 3 the dispersion image of zirconium corundum abrasive grains that have undergone a treatment according to the invention according to test 7.3 can be recognized. An extraordinarily dense covering of the support with solid particles can be seen. With a good dispersibility of this type, combined with an almost complete suppression of the dust development, the abrasive grain according to the invention can be processed in the electrostatic field in an ideal manner, which in particular for the manufacturer of corresponding grinding materials on a support brings with it enormous production advantages.

In the framework of the above-described invention, a number of other tests were carried out in which in particular the concentrations of the aqueous solutions and the treatment amounts of polyol or waterglass were varied in the ranges given in the specification. These tests, which are not explicitly listed here, have in particular shown that the concentrations can be varied over a wide range without the positive effect with respect to dispersibility and dust development being lost thereby in comparison with the prior art.

1. Solid particles from the group corundum, melted corundum, sintered corundum, zirconium corundum, silicon carbide, boron carbide, cubic boron nitride, diamond and/or mixtures thereof, which have a surface treatment in the form of a physically applied coating, characterized in that the coating comprises at least one polyol.

2. Solid particles according to claim 1, characterized in that the amount of polyol is approximately 0.001 to approximately 5% by weight, preferably approximately 0.01 to approximately 1.0% by weight, relative to the untreated solid particle.

3. Solid particles according to claim 2, characterized in that the polyol is a linear polyol with 2 to 6 carbon atoms.

4. Solid particles according to claim 3, characterized in that the polyol is selected from the group polyol, propane diol, butane diol, and glycerol.

5. Solid particles according to claim 4, characterized in that the coating additionally comprises waterglass.

6. Solid particles according to claim 5, characterized in that the amount of waterglass relative to the untreated solid particles is 0.001 to 2.0% by weight.

7. Solid particles according to claim 4, characterized in that the coating additionally comprises a silane with the general empirical formula (RO)3-Si—(CH2)n-X, where R is an organic radical selected from the group methyl, ethyl, i-propyl and methoxymethyl, n is an integer between 0 and 12, and X is a functional group selected from the group vinyl, acryl, methacryl and/or amine.

8. Solid particles according to claim 7, characterized in that the silane is selected from the group 3-aminopropyltriethoxysilane, vinyltriethoxysilane, 3-methacryloxypropyltrimethoxysilane.

9. Solid particles according to claim 8, characterized in that the amount of organosilane relative to the untreated solid particles is 0.01 to 2.0% by weight.

10. A method for the production of solid particles comprising the steps of:
mixing solid particles in an intensive mixer; and
spraying said solid particles with an aqueous solution of a polyol under constant mixing.

11. Method according to claim 10, characterized in that the ratio of polyol to water is approximately 2:1 to approximately 1:40.

12. Method according to claim 11, characterized in that the aqueous solution of the polyol comprises between 0.001 through 2.0% by weight waterglass, relative to the untreated solid particles.

13. Method according to claim 11, characterized in that the solid particles undergo a treatment with 0.01 to 2.0 organosilane before the treatment with the aqueous solution of the polyol.

14. Use of the solid particles according to claim 9 for the production of grinding materials on a support.

15. Solid particles according to claim 1, characterized in that the polyol is a linear polyol with 2 to 6 carbon atoms.

16. Solid particles according to one of claim 1, characterized in that the polyol is selected from the group polyol, propane diol, butane diol, and glycerol.

17. Solid particles according to one of claim 1, characterized in that the coating additionally comprises waterglass (sodium metasilicate also known as sodium silicate).

18. Solid particles according to claim 17, characterized in that the amount of waterglass relative to the untreated solid particles is 0.001 to 2.0% by weight.

19. Solid particles according to one of claim 1, characterized in that the coating additionally comprises a silane with the general empirical formula (RO)3-Si—(CH2)n-X, where R is an organic radical selected from the group methyl, ethyl, i-propyl and methoxymethyl, n is an integer between 0 and 12 and X is a functional group selected from the group vinyl, acryl, methacryl and/or amine.

20. Solid particles according to claim 19, characterized in that the silane is selected from the group 3-aminopropyltriethoxysilane, vinyltriethoxysilane, 3-methacryloxypropyltrimethoxysilane.

21. Solid particles according to claim 19, characterized in that the amount of organosilane relative to the untreated solid particles is 0.01 to 2.0% by weight.

22. The method according to claim 10, characterized in that the aqueous solution of the polyol comprises between 0.001 through 2.0% by weight waterglass, relative to the untreated solid particles.

23. The method according to claim 10, characterized in that the solid particles undergo a treatment with 0.01 to 2.0 organosilane before the treatment with the aqueous solution of the polyol.
